(19) United States
(12) Patent Application Publication
(10) Pub. No.: US 2009/0263759 A1
(43) Pub. Date: Oct. 22, 2009

(54) METHOD AND APPARATUS FOR DETECTING ABNORMALITY IN TOOTH STRUCTURE

(75) Inventor: Maarten Van Herpern, Eindhoven (NL)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., EINDHOVEN (NL)

(21) Appl. No.: 11/722,163

(22) PCT Filed: Dec. 15, 2005
(86) PCT No.: PCT/IB05/54259

§ 371 Date: Jun. 19, 2007

(30) Foreign Application Priority Data
Dec. 20, 2004 (EP) 04300923.2

(51) Int. Cl. A61C 3/00

(52) U.S. Cl. 433/29; 433/215

(57) ABSTRACT

An illuminating radiation beam is directed toward a potentially or actually carious structure (particularly a tooth). A detector detects acoustic oscillations set up in the structure resultant from the illuminating radiation and produces an output signal dependent upon the magnitude of the oscillations detected. Signals from the detector are processed to predict the presence or magnitude of carious infection of the structure.

The present invention relates to investigation of the potential presence of one or more abnormalities in a tooth structure, which would be a potential indication for the presence of tooth decay.

Photo-acoustic techniques for investigating the structure of teeth are known. WO-A-02/054948 discloses a means of assessing the internal structure of teeth using ultrasound (acoustic waves) generated by a short pulse laser beam incident with the teeth.

An improved technique has now been devised.

According to a first aspect, the present invention provides apparatus for investigation the structure of a tooth portion, the apparatus comprising:
an illumination arrangement operable to direct illuminating radiation toward the tooth portion;
a detector arrangement for detecting acoustic oscillations set up in the tooth portion resultant from the illuminating radiation and arranged to produce an output signal dependent upon the magnitude of the oscillations detected; and,
a processor to process signals from the detector dependent upon the magnitude of the oscillations detected, to predict the presence of an abnormality in the tooth portion structure.

According to a second aspect, the invention provides method of investigating a tooth portion structure, the method comprising:
directing illuminating radiation to illuminate the tooth portion;
detecting acoustic oscillations set up in the tooth portion structure resultant from the illuminating radiation and producing an output signal dependent upon the magnitude of the oscillations detected; and,
processing signals from the detector dependent upon the magnitude of the oscillations detected, to predict the presence of an abnormality in the tooth portion structure

The present invention relies in a broadest aspect upon the utilisation of the knowledge that there is a difference in scattering, fluorescence and absorption between teeth with and without caries present. It has been noted in prior art that caries absorbs more light than non-carious regions in the 400-600 nm spectral domain. The present invention stems from this knowledge and that for a given intensity of illumination radiation, the resultant acoustic waves will be strongest (of highest amplitude/intensity) where caries exist.

In an exemplary embodiment, the illuminating radiation is of a preselected spectral wavelength profile, and the processor determines the magnitude of the detected vibrations to predict the presence or magnitude of carious infection of the structure. The present invention can therefore rely upon the fact that higher intensity/amplitude acoustic waves are produced where caries are present. This is particularly true where the illuminating radiation is preselected to match to a preferential absorption frequency profile typical for caries.

The technique can be used with pre-calibration such that a detected signal of a given amplitude/intensity of vibration for a given wavelength and intensity illuminating radiation is indicative of the presence of caries in the tooth under examination.

Alternatively and in some instances the technique can be used to compare output vibrations magnitudes detected from different wavelength illuminating radiation inputs (typically one preselected to match to a preferential absorption frequency profile typical for caries, and the other not). Accordingly, it may be preferred that the illuminating radiation is directed to illuminate the structure in a specific illuminating regime, in which illuminating radiation of preselected different spectral wavelength profiles is used and the processor determines and/or compares the magnitude of the detected vibrations for the preselected different spectral wavelength profiles to predict the presence or magnitude of carious infection of the structure.

The preselected wavelength profiles may comprise a respective bandwidth (or bandwidths) of wavelength or may be discrete wavelengths. Also frequencies outside the discrete frequency or bandwidth may be present but are preferably incidental and preferably of significantly lower intensity than the preselected discrete frequency or bandwidth. Broad band wavelength illumination is preferably not used, however it can be effective enough to provide a practicable solution.

Infra red illuminating radiation is preferably used, because this has strong absorption for decaying enamel which may be indicative of caries presence. Also infra red illuminating radiation has good penetration into the tooth (of the order of a few millimetres). Visible light may be used as an alternative although this is in some ways less preferable.

The invention will now be further described, in specific embodiments, by way of example only and with reference to the accompanying drawings in which:

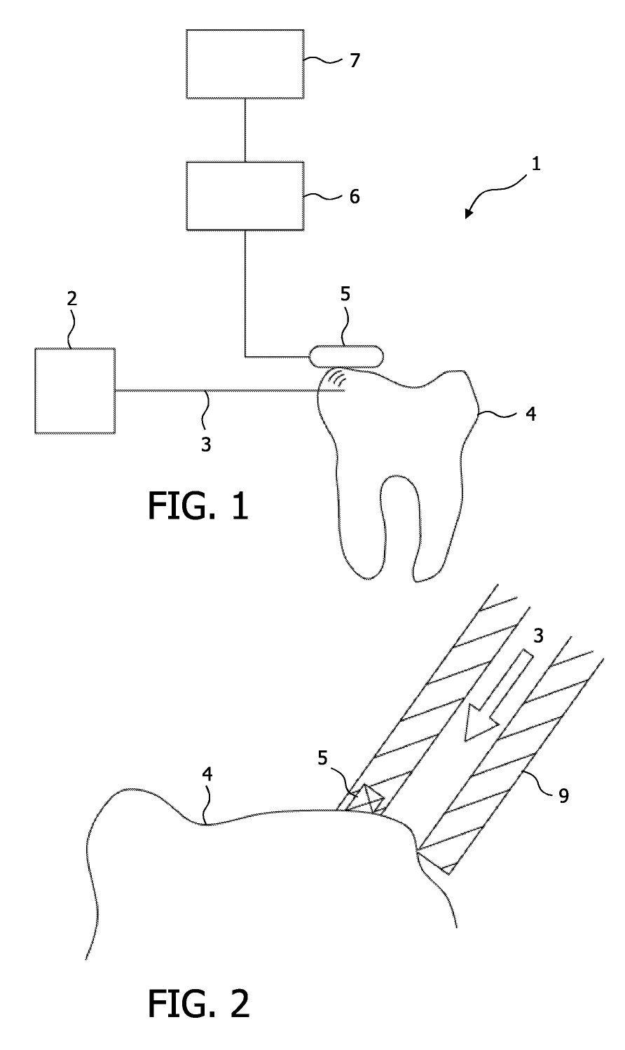

FIG. 1 is a schematic representation of a first embodiment apparatus of the invention; and

FIG. 2 is a schematic representation of a second embodiment apparatus of the invention.

Referring to the drawings, and initially to FIG. 1, there is shown an abnormality detection and investigation system 1. The system comprises a laser light source 2 arranged to produce an output beam 3 which is directed to illuminate a tooth 4. Dependent upon the precise technique used, the illuminating beam may be a narrow beam to produce a small spot. Alternatively the light may flood the entire tooth 4 or a large part of the tooth. The beam will typically be pulsed.

In an exemplary embodiment, a discrete wavelength or narrow wavelength band of illuminating radiation is produced, possibly in the infra red region of the spectrum. In the technique, typically a second different wavelength beam will be directed either sequentially or contemporaneously with the first wavelength (infra red) beam. The second wavelength beam of illuminating radiation is typically of different discrete wavelength or wavelength band to the first wavelength beam (and may not be in the infra red region of the spectrum). The laser source may be tunable to achieve this or discrete sources producing the different wavelength outputs may be utilised. In certain embodiments it may be necessary only that a single beam need be used. A piezoelectric detector 5 is in contact with the exterior surface of the tooth 4. The piezoelectric detector 5 produces output signals dependant upon the magnitude/amplitude of the ultrasonic oscillations/vibrations generated at and below the surface of the tooth. The output signals pass to a processor 6 which may be connected to a display output 7. As an alternative to using a piezoelectric detector 5 an optical detector such as a laser Doppler detector or laser interferometer may be used.

The illuminating radiation (light) from the laser source 2 may be used to illuminate an entire tooth, or a smaller part of it. Depending on the wavelength, the light will be absorbed in the tooth, which will induce a short increase in temperature. The temperature change causes thermal expansion and this will yield a sound wave, which travels through the tooth and is detected at the surface. This mechanism is disclosed in WO-A-02/054948A1. The strength of the detected sound wave gives a value for the absorption of the light in the tooth. This information about absorption can be used in order to detect caries in the tooth.

Infrared radiation is potential efficient illumination source because infrared radiation between 1000 and 1600 cm⁻¹ has strong absorptions for decaying enamel, which is an indication of caries. Alternatively visible light frequencies can be used. An advantage of using infrared radiation is that it has a bigger penetration dept into the tooth (in the order of a few mm).

In a first embodiment the entire tooth is illuminated with different discrete light frequencies. For every frequency the absorption is determined from the amplitude of the generated acoustic wave. Therefore the light is used in a specific illuminating regime, in which illuminating radiation of preselected different spectral wavelength profiles is used and the processor 6 determines and/or compares the magnitude of the detected vibrations for the preselected different spectral wavelength profiles to predict the presence or magnitude of carious infection of the structure.

One of the light frequencies is selected to preferentially be absorbed by caries rather than healthy portions of a tooth. This means that a powerful acoustic wave is generated only if abnormalities, e.g. indicative of carious regions, are present. In this way it is possible to determine whether or not there is a carious area on a tooth.

An advantage of this method is that very quickly it can be determined whether or not a tooth has been infected with caries for example.

In order to determine more precisely which area of the tooth presents the abnormality, a possible solution is to scan parts of the tooth and constructing an image from the acquired information.

In order to do this the tooth is only illuminated in a small spot by the laser beam. The acoustic wave that is generated will then carry only information about the small spot that is illuminated. By moving the spot over the tooth, different sections can be scanned and a complete image of the tooth can be constructed by processing at the processor 6 and rendered as an image at the display 7. Note that only the light source needs to be scanned, so the acoustic sensor 5 does not need to be moved. It is possible to use a fibre 9 to direct the light to the tooth 4. When using a fibre it is possible to incorporate the detector 5 into the end of the fibre. This is shown in FIG. 2. The dentist or physician can then place the end of the fibre into the tooth and when doing so the detector 5 will be placed close to the illuminated region of the tooth, at which location the acoustic signal will be strongest.

The light frequencies that are used can be light frequencies where caries absorbs significantly more power than a healthy tooth. However, if such a frequency is not available, it is also possible to use a wider frequency range in which caries causes just minor changes (such as 400-600 nm range). Because this step uses a very small spot, it is possible to detect these minor changes accurately.

The technique of the invention may is used first to find whether or not a tooth has abnormalities, indicating the presence of potential caries, which will be ultimately diagnosed by a dentist or a doctor. If an abnormality is detected, the second step analysis is used to take an image of the tooth to see which part of the tooth has been damaged and possibly infected.

This combines the speed of analysis benefits of the first technique step (ascertain whether abnormalities or caries are likely to be present) with the image and accuracy of the second step of the technique in which detailed analysis is undertaken.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. Aspects of the invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. Apparatus for investigation of a tooth structure, the apparatus comprising:
an illumination arrangement operable to direct illuminating radiation toward a portion of the tooth;
a detector arrangement for detecting acoustic oscillations set up in the tooth portion resultant from the illuminating radiation and arranged to produce an output signal dependent upon the magnitude of the oscillations detected; and,
a processor to process signals from the detector dependent upon the magnitude of the oscillations detected, to predict the presence of an abnormality in the tooth structure.

2. Apparatus according to claim 1, wherein the illuminating radiation is of a preselected spectral wavelength profile, and the processor determines the magnitude of the detected vibrations to predict the presence the abnormality in the structure or a magnitude of the abnormality.

3. Apparatus according to claim 1, wherein the illuminating radiation is directed to illuminate the structure in a specific illuminating regime, in which illuminating radiation of preselected different spectral wavelength profiles is used and the processor determines the magnitude of the detected vibrations for the preselected different spectral wavelength profiles to predict the presence the abnormality in the structure.

4. Apparatus according to claim 1, wherein the illuminating radiation (3) is in the infra red region of the spectrum.

5. Apparatus according to claim 1, wherein the illuminating radiation is laser radiation.

6. Apparatus according to claim 1, wherein the detector arrangement includes a piezoelectric transducer.

7. Apparatus according to claim 1, wherein the detector arrangement comprises an optical detector arrangement.

8. Apparatus according to claim 1, wherein the illuminating radiation is selected to match a preferential absorption frequency profile typical for caries present in the structure.

9. Apparatus according to claim 1, wherein the processor includes image rendering means for processing the detector data and enabling rendering of an image on a display representative of the structure and the presence of the abnormality in the structure.

10. Apparatus according to claim 15, wherein the illumination arrangement includes a fibre light guide and the detector is mounted proximate the end of the fibre light guide.

11. A method of assessing the integrity of a structure, the method comprising:
directing illuminating radiation to illuminate the structure; detecting acoustic oscillations set up in the structure resultant from the illuminating radiation and producing an output signal dependent upon the magnitude of the oscillations detected; and, processing signals from the detector dependent upon the magnitude of the oscillations detected, to predict the presence of an abnormality in the structure.
